(19) United States
(12) Patent Application Publication
(10) Pub. No.: US 2019/0284392 A1
(43) Pub. Date: Sep. 19, 2019

(54) METHOD FOR MANUFACTURING A THERMOPLASTIC RESIN COMPOSITION

(71) Applicants: DENKA COMPANY LIMITED, Tokyo (JP); NATIONAL UNIVERSITY CORPORATION YAMAGATA UNIVERSITY, Yamagata-shi (JP)

(72) Inventors: Yuichi SHINDO, Ichihara-city (JP); Tomoki KOBAYASHI, Ichihara-city (JP); Kohhei NISHINO, Ichihara-city (JP); Tetsuo TAKAYAMA, Yonezawa-shi (JP)

(73) Assignees: DENKA COMPANY LIMITED, Tokyo (JP); NATIONAL UNIVERSITY CORPORATION YAMAGATA UNIVERSITY, Yamagata-shi (JP)

(21) Appl. No.: 16/431,234

(22) Filed: Jun. 4, 2019

Related U.S. Application Data
(62) Division of application No. 15/762,926, filed on Mar. 23, 2018.

(30) Foreign Application Priority Data
Oct. 6, 2015 (JP) 2015-198827

(51) Int. Cl. C08L 69/00; C08F 279/04; C08F 220/08; C08F 212/10; C08L 51/06; C08L 35/06; C08L 55/02

(52) U.S. Cl. CPC C08L 69/00; C08F 279/04; C08F 220/08; C08L 55/02; C08L 51/06; C08L 35/06; C08F 212/10

(57) ABSTRACT

An object of the present invention is to provide a PC/ABS-based thermoplastic resin composition and a molded article thereof excellent in impact resistance. A thermoplastic resin composition comprising: a polycarbonate (A); at least one resin (B) selected from the group consisting of an ABS resin, an ASA resin, an AES resin and a SAN resin; an unsaturated dicarboxylic acid anhydride-based copolymer (C); and an additive (D), wherein the additive (D) has a function promoting hydrolysis of polycarbonate, and with a content of (C) is 2 to 25 parts by mass.

### CROSS-REFERENCE TO RELATED APPLICATIONS

This application is a divisional of U.S. application Ser. No. 15/762,926, filed Mar. 23, 2018 in the U.S. Patent and Trademark Office, which is a national stage of International Application No. PCT/JP2016/079632, filed Oct. 5, 2016, which claims the benefit of priority to Japanese Application No. 2015-198827, filed Oct. 6, 2015, in the Japanese Patent Office, the disclosures of which are incorporated herein in their entireties by reference.

### TECHNICAL FIELD

The present invention relates to a thermoplastic resin composition and a molded article thereof.

### BACKGROUND ART

Since a resin composition comprising a polycarbonate and an ABS resin (hereinafter referred to as “PC/ABS resin”) is excellent in impact resistance, heat resistance and molding workability, PC/ABS resin has been used for various purposes including automobile parts, home electric appliances, office equipment parts. Improvement in further impact resistance is required for PC/ABS resin, and there are the following approaches for improving the impact resistance of PC/ABS resin.

### CITATION LIST

### Patent Literature

PLT1:JPH10-226748
PLT2:JPH11-60851
PLT3:JP2001-226576

### SUMMARY OF INVENTION

### Technical Problem

An object of the present invention is to provide a novel PC/ABS-based thermoplastic resin composition and a molded article thereof.

### Solution to Problem

(1) A thermoplastic resin composition comprising: a polycarbonate (A); at least one resin (B) selected from the group consisting of an ABS resin, an ASA resin, an AES resin and a SAN resin; an unsaturated dicarboxylic acid anhydride-based copolymer (C); and an additive (D), wherein the additive (D) has a function promoting hydrolysis of polycarbonate, and with respect to 100 parts by mass of a total amount of (A) to (C), a content of (A) is 30 to 93 parts by mass, a content of (B) is 5 to 68 parts by mass, a content of (C) is 2 to 25 parts by mass.

(2) The thermoplastic resin composition of (1), wherein the unsaturated dicarboxylic acid anhydride-based monomer unit of the copolymer (C) is 0.5 to 30 mass %.

(3) The thermoplastic resin composition of (1) or (2), wherein the additive (D) is an organic salt.

(4) The thermoplastic resin composition of (3), wherein the organic salt is a fatty acid metal salt.

(5) The thermoplastic resin composition of any one of 1 to 4, wherein with respect to 100 parts by mass of a total amount of (A) to (C), a content of the additive (D) is 0.01 to 0.90 parts by mass.

(6) A molded article comprising the thermoplastic resin composition of any one of (1) to (5).

### Advantageous Effects of Invention

The thermoplastic resin composition of the present invention is excellent in impact resistance and is useful for automobile parts, home electric appliances, office equipment parts, and the like.

### DESCRIPTION OF EMBODIMENTS

### Explanation of Terms

In the present specification, the description “A to B” means A or more and B or less.

Detailed descriptions are given below to embodiments of the present invention.

A thermoplastic resin composition of the present invention is a composition comprising: a polycarbonate (A); at least one resin (B) selected from the group consisting of an ABS resin, an ASA resin, an AES resin and a SAN resin; an unsaturated dicarboxylic acid anhydride-based copolymer (C); an additive (D), wherein the additive (D) has a function promoting hydrolysis of polycarbonate. With respect to 100 parts by mass of a total amount of (A) to (C), a content of (A) is 30 to 93 parts by mass, a content of (B) is 5.0 to 68 parts by mass, a content of (C) is 2.0 to 25 parts by mass. Preferably, the content of (A) is 45 to 81 parts by mass, the content of (B) is 15 to 50 parts by mass, the content of (C) is 4.0 to 20 parts by mass. More preferably, the content of (A) is 45 to 60 parts by mass, the content of (B) is 25 to 50 parts by mass, the content of (C) is 5.0 to 15 parts by mass. In particular, more preferably, the content of (C) is 7.0 to 13 parts by mass. When the content of (C) is too small, the impact resistance may not be sufficiently improved, when the content of (C) is too much, the impact resistance may be deteriorated.

The polycarbonate (A) is a polymer having a carbonate bond represented by a general formula —[—O—R—O—C(═O)—]—. R is generally hydrocarbon. Depending on the type of a divalent hydroxy compound as a raw material, R include, for example, aromatic polycarbonate, aliphatic polycarbonate, and alicyclic polycarbonate. The polycarbonate (A) may be a homopolymer composed of a single type of a repeating unit or may be a copolymer composed of two or more types of repeating units. Polycarbonate synthesized from bisphenol A as a raw material which is a dihydroxy compound is widely produced for industrial applications and is preferably used herein.

For a method of producing the polycarbonate (A), a known technique may be employed. Examples of the method include ester interchange (also called as a melting method or a melt polymerization method) where bisphenol A and diphenyl carbonate are melted at high temperatures for transesterification during removal of phenol produced under a reduced pressure, a phosgene method (also called as an interfacial polymerization method) where phosgene reacts with an aqueous caustic soda solution or an aqueous suspension of bisphenol A in the presence of methylene chloride, a pyridine method in which phosgene is reacted with bisphenol A in the presence of pyridine and methylene chloride, and the like.

The polycarbonate (A) preferably has a weight average molecular weight 10,000 to 200,000 and more preferably 10,000 to 100,000. The weight average molecular weight of the polycarbonate (A) is a polystyrene equivalent measured by gel permeation chromatography (GPC).

The resin (B) is selected from the group consisting of an ABS resin, an ASA resin, an AES resin and a SAN resin, may be composed of a single type or more types in combination.

The ABS resin, ASA resin and AES resin are graft copolymers obtained by graft copolymerizing at least a styrene monomer and an acrylonitrile monomer to a rubber-like polymer. When a butadiene-based rubber such as polybutadiene or styrene-butadiene copolymer is used as the rubber-like polymer, the graft copolymer is ABS resin. When an acrylic rubber comprising butyl acrylate, ethyl acrylate or the like is used as the rubber-like polymer, the graft copolymer is ASA resin. When an ethylene-based rubber such as an α-olefin copolymer is used as the rubber-like polymer, the graft copolymer is AES resin. At the time of graft copolymerization, two or more of these rubber-like polymers may be used in combination.

As a method for producing a graft copolymer such as ABS resin, a known method can be used. For example, a production method by emulsion polymerization or continuous bulk polymerization can be used.

As a method for producing a graft copolymer by emulsion polymerization, there is a method of emulsion graft copolymerizing a styrene-based monomer and an acrylonitrile-based monomer to a rubber-like polymer latex (hereinafter referred to as “emulsion graft polymerization method”). A latex of the graft copolymer can be obtained by the emulsion graft polymerization method.

In the emulsion graft polymerization method, water, an emulsifier, a polymerization initiator, a chain transfer agent are used, and the polymerization temperature is preferably in the range of 30 to 90° C. Examples of the emulsifier include an anionic surfactant, a cationic surfactant, an amphoteric surfactant, a nonionic surfactant and the like. Examples of the polymerization initiator include: an organic peroxide such as cumene hydroperoxide, diisopropylbenzene peroxide, t-butyl peroxyacetate, t-hexyl peroxybenzoate, t-butyl peroxybenzoate; a persulfate such as potassium persulfate and ammonium persulfate; an azo compound such as azobisbutyronitrile; a reducing agent such as iron ion; a secondary reducing agent such as sodium formaldehyde sulfoxylate; a chelating agent such as disodium ethylenediaminetetraacetate; and the like. Examples of the chain transfer agent include n-octyl mercaptan, n-dodecyl mercaptan, t-dodecyl mercaptan, α-methyl styrene dimer, ethyl thioglycolate, limonene, terpinolene and the like.

The latex of the graft copolymer can be coagulated by a known method to recover the graft copolymer. For example, the latex of the graft copolymer is coagulated by adding a coagulating agent thereto, the graft copolymer is washed and dewatered by a dewaterer, and then followed by a drying step to obtain a powdery graft copolymer.

A content of the residual monomer in the powdery graft copolymer obtained by the emulsion graft polymerization method is preferably less than 15,000 μg/g, more preferably less than 8,000 μg/g. The content of the residual monomer can be controlled by polymerization conditions. And the content value is determined by gas chromatography.

From the viewpoint of impact resistance, a content of the rubber-like polymer in the graft copolymer obtained by the emulsion graft polymerization method is preferably 40 to 70 mass %, more preferably 45 to 65 mass %. The content of the rubber-like polymer can be controlled by, for example, the ratio of the styrene monomer and the acrylonitrile monomer with respect to the rubber-like polymer in the emulsion graft polymerization.

From the viewpoint of impact resistance of the thermoplastic resin composition, the constituent units of the graft copolymer obtained by the emulsion graft polymerization method excluding the rubber-like polymer preferably are 70 to 85 mass % of a styrene-based monomer unit and 15 to 30 mass % of an acrylonitrile-based monomer unit.

A gel content of the graft copolymer is preferably in the form of particles. The gel content is a rubber-like polymer particle graft-copolymerized with a styrene-based monomer and an acrylonitrile-based monomer, which is insoluble in an organic solvent such as methyl ethyl ketone or toluene and separated by centrifugal separation. In some cases, an occlusion structure in which a styrene-acrylonitrile copolymer is involved in the form of a particle is formed inside the rubber-like polymer particles. When the graft copolymer and the styrene-acrylonitrile copolymer are melt blended, the gel content exists as a dispersed phase in the form of particles in the continuous phase of the styrene-acrylonitrile copolymer. The gel content is calculated according to a formula, “Gel Content (mass %)=(SNV)×100”. The graft copolymer having a mass W is dissolved in methyl ethylene ketone, centrifuged at 20000 rpm using a centrifuge to precipitate insoluble matter, the supernatant liquid is removed by decantation, and then the insoluble matter is dried in vacuum to provide the dried insoluble matter having a mass S. For the resin composition obtained by melt blending the graft copolymer and the styrene-acrylonitrile copolymer, the gel content may be calculated in the same manner. That is, the resin composition is dissolved in methyl ethyl ketone and centrifuged.

From the viewpoint of impact resistance and appearance of the molded article, the volume average particle diameter of the gel content of the graft copolymer is preferably in the range of 0.10 to 1.0 μm, more preferably 0.15 to 0.50 μm. The volume average particle diameter is a value calculated from an image analysis of particles dispersed in continuous phase. The image analysis is performed by observing, with transmission electron microscope (TEM), ultrathin sections from pellets of the resin composition obtained by melt blending the graft copolymer and the styrene-acrylonitrile copolymer. The volume average particle size can be controlled by, for example, the particle diameter of the latex of the rubber-like polymer used in the emulsion graft polymerization. The particle size of the latex of the rubber-like polymer can be controlled by the method of adding the emulsifier and the amount of water used during the emulsion polymerization. However, in order to bring the particle size into the preferable range, a long polymerization time is required and the productivity is low. Therefore, a method where a rubber-like polymer having a particle diameter of about 0.1 μm is polymerized in a short time and the rubber particles are enlarged by chemical aggregation method or physical aggregation method may be used.

From the viewpoint of impact resistance, the graft ratio of the graft copolymer is preferably 10 to 100 mass %, more preferably 20 to 70 mass %. The graft ratio is a value calculated according to a formula “graft ratio (mass %)=[(G−RC)/RC]×100”, G is the gel content and RC is the content of the rubber-like polymer. The graft ratio refers to an amount of the styrene-acrylonitrile copolymer per unit mass of the rubber-like polymer, the styrene-acrylonitrile copolymer bonded by graft to the rubber-like polymer particles and contained in the rubber-like polymer particles. The graft ratio is controlled by, for example, during emulsion graft polymerization, a ratio of the monomer to the rubber-like polymer, the type and amount of the initiator, the amount of the chain transfer agent, the amount of the emulsifier, the polymerization temperature, the charging method (collectively/multistage/continuous), the addition rate of the monomer, and the like.

The toluene swelling degree of the graft copolymer is preferably 5 to 20 times from the viewpoint of impact resistance and appearance of the molded article. The toluene swelling degree represents the degree of crosslinking of the particles of the rubber-like polymer, and the graft copolymer is dissolved in toluene, the insoluble matter is separated by centrifugation or filtration, and the toluene swelling degree is calculated from a mass ratio of a mass in the state of being swollen with toluene and a mass in the dry state after vacuum drying to remove toluene. The toluene swelling degree is influenced by the degree of crosslinking of the rubber-like polymer used for the emulsion graft polymerization. The degree of crosslinking of the rubber-like polymer is, for example, controlled by the degree of crosslinking of the initiator, and addition of the emulsifier, the polymerization temperature, a polyfunctional monomer such as divinylbenzene.

The SAN resin is a copolymer having a styrene-based monomer unit and an acrylonitrile-based monomer unit. For example, the SAN resin is a styrene-acrylonitrile copolymer.

Examples of other copolymerizable monomers of the SAN resin include a (meth) acrylic acid ester-based monomer such as methyl methacrylate, an acrylic acid ester-based monomer such as butyl acrylate and ethyl acrylate, a (meth) acrylic acid-based monomer such as methacrylic acid, an acrylic acid-based monomer such as acrylic acid, and a N-substituted maleimide-based monomer such as N-phenyl maleimide.

From the viewpoint of compatibility with the polycarbonate, the constituent unit of the SAN resin preferably contains 60 to 90 mass % of a styrene-based monomer unit and 10 to 40 mass % of a vinyl cyanide-based monomer unit, more preferably contains 70 to 85 mass % of a styrene-based monomer unit and 15 to 30 mass % of a vinyl cyanide-based monomer unit. The contents of the styrene-based monomer unit and the vinyl cyanide-based monomer unit are measured by 13C-NMR.

As a manufacturing method of the SAN resin, a known method can be used. For example, the SAN resin can be produced by bulk polymerization, solution polymerization, suspension polymerization, emulsion polymerization or the like. As a method of operating the reaction apparatus, any of continuous type, batch type (batch type), semi-batch type can be applied. From the viewpoint of quality and productivity, bulk polymerization or solution polymerization is preferred, and continuous type is specifically preferred. Examples of solvents for bulk polymerization or solution polymerization include alkylbenzenes such as benzene, toluene, ethylbenzene and xylene, ketones such as acetone and methyl ethyl ketone, aliphatic hydrocarbons such as hexane and cyclohexane, and the like.

For bulk polymerization or solution polymerization of the SAN resin, the polymerization initiator and the chain transfer agent can be used, and the polymerization temperature is preferably in the range of 120 to 170° C. Examples of the polymerization initiator include: peroxy ketals such as 1,1-di (t-butylperoxy) cyclohexane, 2,2-di (t-butylperoxy) butane, 2,2-di (4,4-di-peroxycyclohexyl) propane and 1,1-di (t-amylperoxy) cyclohexane; hydroperoxides such as cumene hydroperoxide and t-butyl hydroperoxide; alkyl peroxides such as t-butyl peroxyacetate and t-amyl peroxy isononanoate; dialkyl peroxides such as t-butyl cumyl peroxide, di-t-butyl peroxide, dicumyl peroxide and di-t-hexyl peroxide; peroxyesters such as t-butyl peroxyacetate, t-butyl peroxybenzoate, t-butyl peroxy isopropyl monocarbonate; N, N′-azobis (2-methylbutyronitrile); N, N′-azobis (2,4-dimethylvaleronitrile); N, N′-azobis [2-(hydroxymethyl) propionitrile]; and the like. A single type or more types of them in combination may be used. Examples of the chain transfer agent include n-octyl mercaptan, n-dodecyl mercaptan, t-dodecyl mercaptan, α-methyl styrene dimer, ethyl thioglycolate, limonene, terpinolene and the like.

A devolatilization method to remove the volatile components, such as the unreacted monomer, and the solvent used for solution polymerization from the solution after finishing polymerization of the SAN resin may be a known technique. For example, a vacuum devolatilization chamber with a preheater or a vented devolatilization extruder may be used. The devolatilized and molten SAN resin may be transferred to a granulation process and extruded in a strand from a porous die to be processed into pellets by cold cut, air hot cut, or water hot cut.

The total content of the residual monomer and solvent in the SAN resin is preferably less than 2000 μg/g, more preferably less than 1500 μg/g. The content of the residual monomer and solvent can be controlled by devolatilization conditions and is a value determined by gas chromatography.

From the viewpoint of impact resistance and moldability of the resin composition, the weight average molecular weight of the SAN resin is preferably 50,000 to 250,000, more preferably 70,000 to 200,000. The weight average molecular weight of the SAN resin is a polystyrene equivalent measured in THF solvent using gel permeation chromatography (GPC), which is a value measured by the same method as that of the polycarbonate (A). The weight average molecular weight can be controlled by the kind and amount of the chain transfer agent in the polymerization, the solvent concentration, the polymerization temperature, the kind and amount of the polymerization initiator.

An examples of the resin (B) may contain two kinds of resins of a powdered ABS resin obtained by emulsion polymerization and a pelletized SAN resin obtained by continuous bulk polymerization. Another example of the resin (B) may contain a pelletized ABS prepared by melt-blending, in an extruder or the like, a powdered ABS resin obtained by emulsion polymerization and a pelletized SAN resin obtained by continuous bulk polymerization. Another example of the resin (B) may contain a pelletized ABS resin obtained by continuous bulk polymerization and a powdered ABS resin obtained by emulsion polymerization. Another example of the resin (B) may contain a pelletized ABS prepared by melt-blending, in an extruder or the like, a powdered ABS resin obtained by emulsion polymerization and a pelletized ABS resin obtained by continuous bulk polymerization.

The unsaturated dicarboxylic anhydride-based copolymer (C) is a copolymer having unsaturated dicarboxylic anhydride-based monomer units and styrene-based monomer units. In the present invention, this copolymer may further have (meth)acrylate-based monomer units, maleimide-based monomer units, and acrylonitrile-based monomer units. Examples of the unsaturated dicarboxylic anhydride-based copolymer (C) include styrene-methyl methacrylate-maleic anhydride copolymers, styrene-N-phenylmaleimide-maleic anhydride copolymers, styrene-maleic anhydride copolymer, styrene-acrylonitrile-N-phenylmaleimide-maleic anhydride copolymer, and the like.

An unsaturated dicarboxylic anhydride-based monomer includes maleic anhydride, itaconic anhydride, citraconic anhydride, aconitic anhydride, and the like. Among them, maleic anhydride is preferred. The unsaturated dicarboxylic anhydride-based monomer may be composed of one or more types.

Examples of the (meth)acrylate-based monomer unit include: methacrylate monomers, such as methyl methacrylate, ethyl methacrylate, n-butyl methacrylate, 2-ethylhexyl methacrylate, dicyclopentanyl methacrylate, and isobornyl methacrylate; and acrylate monomers, such as methyl acrylate, ethyl acrylate, n-butyl acrylate, 2-methylhexyl acrylate, 2-ethylhexyl acrylate, and decyl acrylate. Among them, methyl methacrylate units are preferred. The (meth)acrylate monomer may be composed of one or more types.

Examples of the maleimide-based monomer unit include structural units derived from the followings: N-alkylmaleimide, such as N-methylmaleimide, N-butylmaleimide, and N-cyclohexylmaleimide; N-arylmaleimide, such as N-phenylmaleimide, N-chlorphenylmaleimide, N-methylphenylmaleimide, N-methoxyphenylmaleimide, and N-tribromophenylmaleimide; and the like. Among them, N-cyclohexylmaleimide and N-phenylmaleimide are preferred. The maleimide-based monomer units may be composed of one or more types.

The ratios of the constituent units of the unsaturated dicarboxylic anhydride-based copolymer (C) are preferably 0.5 to 30 mass % of an unsaturated dicarboxylic anhydride-based monomer unit, 40 to 80 mass % of a styrene-based monomer unit, 0 to 40 mass % of a (meth)acrylate-based monomer unit, 0 to 60 mass % of a maleimide-based monomer unit, and 0 to 30 mass % of an acrylonitrile-based monomer unit. The ratio of the unsaturated dicarboxylic anhydride-based monomer unit is more preferably 5.0 to 30 mass %. The unsaturated dicarboxylic acid anhydride-based copolymer (C) is preferably compatible with the resin (B). For example, when the unsaturated dicarboxylic anhydride-based copolymer (C) is a styrene-methyl methacrylate-maleic anhydride copolymer, the ratio of the maleic anhydride monomer unit is, from the viewpoint of the compatibility with the resin (B) and the thermal stability of the unsaturated dicarboxylic acid anhydride-based copolymer (C), preferably 10 to 40 mass %, more preferably 15 to 30 mass %. When the unsaturated dicarboxylic acid anhydride-based copolymer (C) is a styrene-N-phenylmaleimide-maleic anhydride copolymer, the total ratio of the unsaturated dicarboxylic acid anhydride-based monomer unit and the maleimide-based monomer unit is, from the viewpoint of compatibility with the resin (B), preferably 10 to 70 mass %, more preferably 20 to 60 mass %. The ratio of the unsaturated dicarboxylic anhydride-based monomer unit is measured by the titrimetric method. The ratios of the styrene-based monomer unit, the (meth)acrylate-based monomer unit, the maleimide-based monomer unit, and the acrylonitrile-based monomer unit are measured by 13C-NMR.

The unsaturated dicarboxylic anhydride-based copolymer (C) may be produced by a known method. An example of such a method is a method of copolymerizing a monomer mixture of an unsaturated dicarboxylic anhydride-based monomer, a styrene-based monomer, a (meth)acrylate-based monomer, a maleimide-based monomer, and an acrylonitrile-based monomer. Another example is a method including copolymerizing a monomer mixture of an unsaturated dicarboxylic anhydride-based monomer, a styrene-based monomer, and an acrylonitrile-based monomer, followed by imidation by reacting part of the unsaturated dicarboxylic anhydride-based monomer units with ammonium or primary amine for conversion into maleimide-based monomer units (hereinafter, referred to as “a post-imidation method”).

The unsaturated dicarboxylic anhydride-based copolymer (C) may be produced by a known method. It may be produced by, for example, solution polymerization, bulk polymerization, and the like. Any of the continuous method and the batch method is applicable. Since copolymerization of a styrene-based monomer with an unsaturated dicarboxylic anhydride-based monomer or that of a styrene-based monomer with a maleimide-based monomer has high alternating copolymerizability, solution polymerization is preferred to homogenize the copolymerization composition by split adding the unsaturated dicarboxylic anhydride-based monomer or the maleimide-based monomer for polymerization. Examples of the solvent for solution polymerization include: ketones such as acetone, methyl ethyl ketone, methyl isobutyl ketone, and acetophenone; ethers such as tetrahydrofuran and 1,4-dioxane; aromatic hydrocarbons such as benzene, toluene, xylene, and chlorobenzene; N,N-dimethylformamide; dimethyl sulfoxide; N-methyl-2-pyrrolidone; and the like. For the ease of solvent removal in devolatilization recovery of the unsaturated dicarboxylic anhydride-based copolymer (C), methyl ethyl ketone or methyl isobutyl ketone is preferred.

For solution polymerization or bulk polymerization of the unsaturated dicarboxylic anhydride-based copolymer (C), a polymerization initiator and a chain transfer agent may be used and the polymerization temperature preferably ranges 70 to 150° C. Examples of the polymerization initiator include the followings: azo compounds, such as azobisisobutyronitrile, azobiscyclohexanecarbonitrile, azobismethylproponitrile, and azobismethylbutyronitrile; and peroxides, such as benzoyl peroxide, t-butyl peroxybenzoate, 1,1-di(t-butylperoxy)cyclohexane, t-butyl peroxyisopropyl monocarbonate, t-butylperoxy-2-ethylhexanoate, di-t-butylperoxide, dicumyl peroxide, and ethyl-3,3-di-(t-butylperoxy)butyrate. A single type or more types of them in combination may be used. Examples of the chain transfer agent include n-octyl mercaptan, n-dodecyl mercaptan, t-dodecyl mercaptan, α-methylstyrene dimers, ethyl thioglycolate, limonene, terpinolene, and the like.

The maleimide-based monomer units are introduced into the unsaturated dicarboxylic anhydride-based copolymer (C) by a method of copolymerizing a maleimide-based monomer or by the post-imidation method. The post-imidation method is a method including copolymerizing a monomer mixture of an unsaturated dicarboxylic anhydride-based monomer, a styrene-based monomer, a (meth)acrylate-based monomer, and an acrylonitrile-based monomer, followed by imidation by reacting part of the unsaturated dicarboxylic anhydride-based monomer units with ammonium or primary amine for conversion into maleimide-based monomer units. Examples of the primary amine include the followings: alkylamines, such as methylamine, ethylamine, n-propylamine, iso-propylamine, n-butylamine, n-pentylamine, n-hexylamine, n-octylamine, cyclohexylamine, and decylamine; and aromatic amines, such as chloro- or bromo-substituted alkylamine, aniline, toluidine, and naphtylamine. Among them, aniline or cyclohexylamine is preferred. These primary amines may be used singly or in combination of two or more types. For the post-imidation, in the reaction of the primary amine with the unsaturated dicarboxylic anhydride-based monomer units, a catalyst may be used to improve the dehydrative cyclization reaction. Examples of the catalyst include trimethylamine, triethylamine, tripropylamine, tributylamine, N,N-dimethylaniline, N,N-diethylaniline, and the like. The temperature for the post-imidation is preferably 100-250° C. and more preferably 120-200° C.

A method to remove the solvent used for solution polymerization and the volatile components, such as the unreacted monomer, from the solution after finishing solution polymerization of the unsaturated dicarboxylic anhydride-based copolymer (C) or the solution after finishing the post-imidation may be a known technique. For example, a vacuum devolatilization chamber with a heater or a vented devolatilization extruder may be used. The devolatilized and molten unsaturated dicarboxylic anhydride-based copolymer (C) may be transferred to a granulation process and extruded in a strand from a porous die to be processed into pellets by cold cut, air hot cut, or water hot cut.

The unsaturated dicarboxylic anhydride-based copolymer (D) has a weight average molecular weight of preferably 50,000 to 300,000 and more preferably 80,000 to 200,000. The unsaturated dicarboxylic anhydride-based copolymer (D) The weight average molecular weight of the styrene-acrylonitrile based copolymer (C) is a polystyrene equivalent measured in a THF solvent by gel permeation chromatography (GPC). The weight average molecular weight may be regulated in polymerization by the type and the amount of the chain transfer agent, the solvent concentration, the polymerization temperature, and the type and the amount of the polymerization initiator.

The additive (D) having a function promoting hydrolysis of polycarbonate is an organic salt, an inorganic salt, a fatty acid, a fatty acid amide compound, an amine compound, a hydroxide, a higher alcohol, or the like. Examples of the organic salt include fatty acid metal salts such as magnesium stearate, sodium stearate, lithium stearate, potassium stearate, calcium stearate, barium stearate, zinc stearate, aluminum stearate, lead stearate, acetate such as calcium acetate. Examples of the inorganic salt include sulfates such as magnesium sulfate, sodium sulfate, aluminum sulfate and the like, and chlorides such as calcium chloride, magnesium chloride, sodium chloride. Examples of fatty acids include stearic acid, lauric acid, oleic acid, capric acid, myristic acid, palmitoleic acid, arachidic acid and the like. Examples of fatty acid amide compounds include stearic acid amide, oleic acid amide, erucic acid amide and the like. Examples of the amine compound include hindered amine and the like. Examples of the hydroxide include magnesium hydroxide, sodium hydroxide, lithium hydroxide, potassium hydroxide, calcium hydroxide, barium hydroxide, zinc hydroxide, aluminum hydroxide and the like. Examples of higher alcohols include decyl alcohol, lauryl alcohol, myristyl alcohol, cetyl alcohol, stearyl alcohol and the like. Among these, fatty acid metal salts are preferred, and magnesium stearate, sodium stearate, lithium stearate, and potassium stearate are more preferred. The additives (D) having a function promoting hydrolysis of polycarbonate may be composed of one or more types.

The amount of the additive (D) having a function promoting hydrolysis of polycarbonate is preferably 0.01 to 0.90 parts by mass with respect to 100 parts by mass of the total amount of (A) to (C), more preferably from 0.03 to 0.80 parts by mass, further preferably from 0.05 to 0.70 parts by mass. When the amount of the additive (D) having a function promoting hydrolysis of polycarbonate is too small, the impact resistance of the thermoplastic resin composition may not be sufficiently improved in some cases. When the amount is too much, the impact resistance may be deteriorated.

The thermoplastic resin composition may contain, as long as the effect of the present invention is not impaired, other resin components, an impact modifier, a flowability modifier, a hardness modifier, an antioxidant, an inorganic filler, a matting agent, a flame retardant, a flame retardant aid, a drip prevention agent, a sliding property imparting agent, a heat dissipating material, an electromagnetic wave absorbing material, a plasticizer, a lubricant, a release agent, an ultraviolet absorber, an antibacterial agent, an antifungal agent, an antistatic agent, carbon black, titanium oxide, a pigment, a dye and the like, in addition to the polycarbonate (A), the at least one resin (B) selected from the group consisting of the ABS resin, the ASA resin, the AES resin and the SAN resin, an unsaturated dicarboxylic acid anhydride-based copolymer (C), and an additive (D) having a function promoting hydrolysis of polycarbonate.

The thermoplastic resin composition may be produced by a known method. An example of such a method includes melt blending the polycarbonate (A), the at least one resin (B) selected from the group consisting of the ABS resin, the ASA resin, the AES resin and the SAN resin, an unsaturated dicarboxylic acid anhydride-based copolymer (C), and an additive (D) having a function promoting hydrolysis of polycarbonate with a twin-screw extruder. The twin-screw extruder may be either co-rotating or counter rotating. Other examples of the melt blender include a single-screw extruder, a multi-screw extruder, a twin-rotor continuous kneader, a cokneader, and a Banbury mixer. For use of a twin-screw extruder, cylinder temperature settings may be selected ranging 200-320° C. and preferably 210-290° C.

The amount of water contained in the raw material before melt blending is preferably 0.05 mass % or more, more preferably 0.08 mass % or more. When the amount of water contained in the raw material before melt blending is too small, the impact resistance of the thermoplastic resin composition may not be sufficiently improved in some cases. The amount of water contained in the raw material before melt blending (mass %) is a value calculated from content ratio of each row materials according to a formula: [{weight of raw material before drying (g)−weight of raw material dried in vacuum at 80° C. for 8 hr (g)}/weight of raw material before drying (g)]×100.

The thermoplastic resin composition may be molded by a known method. Examples of the molding method include injection molding, sheet extrusion molding, vacuum molding, blow molding, foam molding, contour extrusion molding, and the like. During general molding, the thermoplastic resin composition is processed after being heated at 200-280° C., preferably 210-270° C. The articles thus molded are applicable to automobile parts, home appliances, business machine parts, and the like.

### Examples

Detailed descriptions are given below with reference to Examples. Note that the present invention is not limited to the following Examples.

For the polycarbonate (A), the following material is used.

(a-1) lupilon S-2000 produced by Mitsubishi Engineering-Plastics Corp.

For the resin (B), the graft copolymer (b-1) and the styrene-acrylonitrile copolymer (b-2) were used.

The graft copolymer (b-1) was prepared by emulsion graft polymerization. 143 parts by mass of polybutadiene latex having an average particle diameter of 0.3 μm, 1.0 part by mass of sodium stearate, 0.2 parts by mass of sodium formaldehyde sulfoxylate, 0.01 parts by mass of tetrazodium ethylenediamine tetraacetic acid, 0.005 part by mass of ferrous sulfate, and 150 parts by mass of pure water were charged, and the temperature was heated to 50° C. 50 parts by mass of a monomer mixture of 75 mass % of styrene and 25 mass % of acrylonitrile, 1.0 part by mass of t-dodecylmercaptan and 0.15 parts by mass of cumene hydroperoxide were split added thereto continuously for 6 hours. After completing split addition, the temperature was raised to 65° C. and polymerization was completed by taking 2 hours to produce latex of the graft copolymer (b-1). The obtained latex was coagulated with hydrochloric acid as a coagulant, followed by washing and dewatering and then drying to obtain a powdered graft copolymer (b-1). For the obtained graft copolymer (b-1), the polybutadiene content is 50 mass % based on the raw material compounding ratio at the time of emulsion graft polymerization. The constituent unit excluding the rubber-like polymer was measured by 13C-NMR. The ratio of styrene was 75 mass % of and the ratio of acrylonitrile was 25 mass %. The gel content obtained by a centrifugal separation method was 72 mass %. The graft ratio was calculated from the gel content and the polybutadiene content to be 44%. The toluene swelling degree was 8.1, and the volume average particle diameter was calculated from the observation result of TEM to be 0.3 μm.

The styrene-acrylonitrile based copolymer (b-2) was prepared by continuous bulk polymerization. Polymerization was performed using one complete mixing stirring chamber as a reactor with a volume of 20 L. A material solution of 60.5 mass % of styrene, 21.5 mass % of acrylonitrile, and 18.0 mass % of ethylbenzene was prepared to be continuously supplied to the reactor at a flow rate of 6.5 L/h. In addition, t-butylperoxyisopropyl monocarbonate as a polymerization initiator and n-dodecyl mercaptan as a chain transfer agent were continuously added at a concentration of, respectively, 160 ppm and 1500 ppm relative to the material solution to a supply line of the material solution. The reaction temperature in the reactor was regulated at 145° C. The polymer solution continuously taken from the reactor was supplied to a vacuum devolatilization chamber with a preheater to separate unreacted styrene, acrylonitrile, and ethylbenzene. The temperature in the preheater was regulated to make the polymer temperature in the devolatilization chamber at 225° C., and the pressure in the devolatilization chamber was 0.4 kPa. The polymer was extracted from the vacuum devolatilization chamber by a gear pump and extruded in a strand and cooled in cooling water, followed by cutting to obtain a pelletized styrene-acrylonitrile based copolymer (b-2). The acrylonitrile unit content in (b-2) was measured by the Kjeldahl method to find 25 mass %. The weight average molecular weight of (b-2) was 105,000. The weight average molecular weight was a polystyrene equivalent measured by gel permeation chromatography (GPC) and measured in the following conditions:

| | |
|---|---|
| Apparatus | SYSTEM-21 Shodex |
| | (manufactured by Showa Denko K.K.); |
| Column | 3 pieces of PL gel MIXED-B in series |
| Temperature | 40° C. |
| Detection | Differential Refractive Index |
| Solvent | Tetrahydrofuran |
| Concentration | 2 mass % |
| Calibration Curve | Prepared using polystyrene standard (PS) |
| | (produced by PL). |

The unsaturated dicarboxylic acid anhydride-based copolymer (c-1) was prepared by solution polymerization. Maleic anhydride was dissolved in methyl isobutyl ketone so that the concentration of maleic anhydride was 20% by mass, and t-butyl peroxy-2-ethylhexanoate was diluted with methyl isobutyl ketone so that the concentration of t-butyl peroxy-2-ethyl hexanoate was 2 mass %. The prepared 20% maleic anhydride solution and 2% t-butyl peroxy-2-ethylhexanoate solution were used for polymerization. To a 120 L autoclave equipped with a stirrer, 3.6 kg of 20% maleic anhydride solution, 24 kg of styrene, 8.8 kg of methyl methacrylate and 20 g of t-dodecyl mercaptan were charged, and the gas phase part was replaced with nitrogen gas. The temperature was raised to 88° C. over 40 minutes with stirring. While maintaining the temperature of 88° C. after the temperature rising, 20% maleic anhydride solution was added at the addition rate of 2.7 kg/h and 2% t-butyl peroxy-2-ethylhexanoate solution was added at the addition rate of 375 g/h, continuously over 8 hours. Thereafter, the addition of 2% t-butyl peroxy-2-ethylhexanoate solution was stopped, and 40 g of t-butyl peroxy isopropyl monocarbonate was added. The solution was heated to 120° C. over 4 hours at the heating rate of 8° C./hr while maintaining the addition rate of 2.7 kg/hour of 20% maleic anhydride solution. The addition of 20% maleic anhydride solution was stopped when the amount of addition reached 32.4 kg in total. After raising the temperature, polymerization was terminated by maintaining 120° C. for 1 hour. The polymerization solution is continuously fed to a twin-screw extruder using a gear pump, the methyl isobutyl ketone and a trace amount of unreacted monomer and the like are subjected to a volatilizing treatment and extruded and cut in a strand form to obtain pellet-shaped styrene based resin (c-1). As a result of analyzing the constituent unit of (c-1) by 13 C-NMR, the content of the styrene unit was 60 mass %, the content of the methyl methacrylate unit was 22 mass %, and the content of the maleic anhydride unit was 18 mass %. The weight average molecular weight of (c-1) was 160,000. The weight average molecular weight of (c-1) was measured by GPC in the same manner as (b-2).

The unsaturated dicarboxylic anhydride-based copolymer (c-2) was prepared by solution polymerization. An autoclave with a stirrer as a reactor was charged with 60 parts by mass of styrene, 8 parts by mass of maleic anhydride, 0.2 parts by mass of an a methylstyrene dimer, and 25 parts by mass of methyl ethyl ketone. The system was purged with nitrogen gas, followed by raising the temperature to 92° C. and adding a solution for 7 hours where 32 parts by mass of maleic anhydride and 0.18 parts by mass of t-butylperoxy-2-ethylhexanoate were dissolved in 100 parts by mass of methyl ethyl ketone. After the addition, 0.03 parts by mass of t-butylperoxy-2-ethylhexanoate was further added and the temperature was raised to 120° C. for further reaction for 1 hour to obtain a polymer solution of a styrene-maleic anhydride copolymer. Then, 30 parts by mass of aniline and 0.6 parts by mass of triethylamine were added to the polymer solution for imidation reaction at 140° C. for 7 hours. The polymer solution after finishing the imidation reaction was supplied to a vented devolatilization extruder for removal of the volatile components to obtain a styrene-N-phenylmaleimide-maleic anhydride copolymer (c-2). The constituents of (c-2) were analyzed by 13-NMR to find 48 mass % of a styrene unit content, 45 mass % of an N-phenylmaleimide unit content, and 7 mass % of a maleic anhydride unit content. The weight average molecular weight of (c-2) was 142,000. The weight average molecular weight of (c-2) was obtained by GPC in the same method as (b-2).

A styrene-N-phenylmaleimide copolymer (e-1) containing no unsaturated dicarboxylic anhydride-based monomer unit was prepared by solution polymerization. An autoclave with a stirrer as a reactor was charged with 48 parts by mass of styrene, 0.08 parts by mass of an a methylstyrene dimer, and 100 parts by mass of methyl ethyl ketone. The system was purged with nitrogen gas, followed by raising the temperature to 85° C. and adding a solution for 8 hours where 52 parts by mass of N-phenylmaleimide and 0.15 parts by mass of benzoyl peroxide were dissolved in 200 parts by mass of methyl ethyl ketone. After the addition, reaction was further performed at 85° C. for 3 hours to obtain a polymer solution of a styrene-N-phenylmaleimide copolymer. The polymer solution after finishing the reaction was supplied to a vented devolatilization extruder for removal of volatile components to produce styrene —N-phenylmaleimide copolymer (e-1). The constituents of (e-1) were analyzed by 13-NMR to find 48 mass % of a styrene unit content and 52 mass % of an N-phenylmaleimide unit content. The weight average molecular weight of (e-1) was 150,000. The weight average molecular weight of (e-1) was obtained by GPC in the same method as (b-2).

The following materials were used as the additive (D) having a function promoting hydrolysis of polycarbonate.

(d-1) Magnesium stearate SM-P produced by Sakai Chemical Industry Co., Ltd.
(d-2) Sodium stearate SNA-100 produced by Sakai Chemical Industry Co., Ltd.

The components (A) to (D) and the styrene-N-phenylmaleimide copolymer (e-1) were dry-blended in the proportions shown in Table 1 and melt extruded using a twin-screw extruder to obtain pellets of the thermoplastic resin compositions of Examples, Comparative Examples and Reference Examples. The twin-screw extruder was a twin-screw extruder TEM-35B manufactured by Toshiba Machine Co., Ltd. with screw diameter D=35 mm and L/D=32. Extrusion conditions were 250 rpm screw speed, 260° C. cylinder temperature, 30 kg discharge rate/h. The obtained strand was cut using a pelletizer to obtain pellets of about 2 mm.

### (Melt Mass Flow Rate)

Melt mass flow rate was measured at 220° C. under 98 N load according to JIS K 7210. TYPE C-5059D manufactured by Toyo Seiki Seisaku-sho, Ltd. was used as a measuring machine.

### (Charpy Impact Strength)

Charpy impact strength was measured using a notched specimen according to JIS K 7111-1, and a striking direction is edgewise. A digital impact tester manufactured by Toyo Seiki Seisaku-sho, Ltd. was used as a measuring machine.

### (Vicat Softening Temperature)

The Vicat softening point was measured according to JIS K 7206 using the 50 method (load 50 N, heating rate 50° C./hour) and the test piece having a size of 10 mm×10 mm and a thickness of 4 mm. An HDT & VSPT testing apparatus manufactured by Toyo Seiki Seisakusho was used as a measuring instrument. The measurement results are shown in Table 1.

TABLE 1

| | | | | Example | | | | | | |
|---|---|---|---|---|---|---|---|---|---|---|
| | | | | 1 | 2 | 3 | 4 | 5 | 6 | 7 |
| Proportion | (A)Component | a-1 | mass part | 50.0 | 50.0 | 50.0 | 50.0 | 50.0 | 50.0 | 50.0 |
| | (B)Component | b-1 | mass part | 15.0 | 15.0 | 15.0 | 15.0 | 15.0 | 15.0 | 15.0 |
| | | b-2 | mass part | 25.0 | 30.0 | 20.0 | 15.0 | 25.0 | 25.0 | 25.0 |
| | (C)Component | c-1 | mass part | 10.0 | 5.0 | 15.0 | 20.0 | — | 10.0 | 10.0 |
| | | c-2 | mass part | — | — | — | — | 10.0 | — | — |
| | e-1 | | mass part | — | — | — | — | — | — | — |
| | (D)Component | d-1 | mass part | 0.5 | 0.5 | 0.5 | 0.5 | 0.5 | — | 0.5 |
| | | d-2 | mass part | — | — | — | — | — | 0.1 | — |

| | | | | | | | | | |
|---|---|---|---|---|---|---|---|---|---|
| | Water Amount before Extrusion | % | 0.12 | 0.12 | 0.12 | 0.12 | 0.12 | 0.12 | 0.07 |
| Evaluation | MFR(280° C., 5 kg) | g/10 min | 10.1 | 12.2 | 8.1 | 5.8 | 7.8 | 9.8 | 11.0 |
| | Charpy Impact Strength | kJ/m2 | 53.5 | 49.3 | 50.2 | 45.1 | 52.1 | 53.6 | 43.1 |
| | Vicat Softening Temperature | kJ/m2 | 119 | 116 | 122 | 125 | 126 | 119 | 117 |

| | | | | Comparative Example | | | | | |
|---|---|---|---|---|---|---|---|---|---|
| | | | | 1 | 2 | 3 | 4 | 5 | 6 |
| Proportion | (A)Component | a-1 | mass part | 50.0 | 50.0 | 50.0 | 50.0 | 50.0 | 50.0 |
| | (B)Component | b-1 | mass part | 15.0 | 15.0 | 15.0 | 15.0 | 15.0 | 15.0 |
| | | b-2 | mass part | 35.0 | 35.0 | 34.0 | 5.0 | 25.0 | 25.0 |
| | (C)Component | c-1 | mass part | — | — | 1.0 | 30.0 | — | 10.0 |
| | | c-2 | mass part | — | — | — | — | — | — |

| e-1 | | mass part | — | — | — | — | 10.0 | — |
|---|---|---|---|---|---|---|---|---|
| (D)Component | d-1 | mass part | — | 0.5 | 0.5 | 0.5 | 0.5 | — |
| | d-2 | mass part | — | — | — | — | — | — |

| | | | | | | | | |
|---|---|---|---|---|---|---|---|---|
| | Water Amount before Extrusion | % | 0.12 | 0.12 | 0.12 | 0.12 | 0.12 | 0.12 |
| Evaluation | MFR(280° C., 5 kg) | g/10 min | 15.4 | 21.1 | 20.1 | 2.9 | 6.8 | 10.4 |
| | Charpy Impact Strength | kJ/m2 | 34.9 | 29.2 | 30.1 | 32.2 | 27.8 | 28.1 |
| | Vicat Softening Temperature | kJ/m2 | 113 | 112 | 113 | 129 | 124 | 118 |

From the results in Table 1, it is found that Examples 1 to 7 using the copolymer (C) and the additive (D) are excellent in impact resistance. On the other hand, in Comparative Examples 1 and 6 in which the additive (D) was not used, the impact resistance was inferior. In Comparative Example 2 in which the copolymer (C) was not added and Comparative Example 5 in which the styrene-N-phenylmaleimide copolymer (e-1) not having the unsaturated dicarboxylic acid anhydride-based monomer unit was added, the impact resistance was inferior. Also, the impact resistance was inferior also in Comparative Example 3 in which the content of Copolymer (C) was less than 2 parts by mass and Comparative Example 4 in which the content was more than 25 parts by mass.

### INDUSTRIAL APPLICABILITY

Since the resin composition of the present invention is excellent in impact resistance, it is useful for automobile parts, home electric appliances, office equipment parts, and the like.

1. A method for manufacturing a thermoplastic resin composition comprising melt blending a raw material, wherein
an amount of water contained in the raw material is preferably 0.05 mass % or more, and
the raw material comprises:
a polycarbonate (A);
at least one resin (B) selected from the group consisting of an ABS resin, an ASA resin, an AES resin and a SAN resin;
an unsaturated dicarboxylic acid anhydride-based copolymer (C); and
an additive (D), wherein
the additive (D) has a function promoting hydrolysis of polycarbonate, and
with respect to 100 parts by mass of a total amount of (A) to (C), a content of (A) is 30 to 93 parts by mass, a content of (B) is 5 to 68 parts by mass, a content of (C) is 2 to 25 parts by mass.

2. The method of claim 1, wherein the unsaturated dicarboxylic acid anhydride-based monomer unit of the copolymer (C) is 0.5 to 30 mass %.

3. The method of claim 1, wherein the additive (D) is an organic salt.

4. The method of claim 3, wherein the organic salt is a fatty acid metal salt.

5. The method of claim 1, wherein with respect to 100 parts by mass of a total amount of (A) to (C), a content of the additive (D) is 0.01 to 0.90 parts by mass.

6. A method for manufacturing a molded article comprising the thermoplastic resin composition manufactured by the method of claim 1.
